(19) United States
(12) Patent Application Publication
(10) Pub. No.: US 2017/0031886 A1
(43) Pub. Date: Feb. 2, 2017

(54) CONTEXTUAL PROFILE

(71) Applicant: LinkedIn Corporation, Mountain View, CA (US)

(72) Inventors: Nipun Dave, Mountain View, CA (US); Hari Srinivasan, San Francisco, CA (US); James Michael Fell, San Jose, CA (US); Vibha Rathi, Cupertino, CA (US)

(21) Appl. No.: 14/813,020

(22) Filed: Jul. 29, 2015

(51) Int. Cl. G06F 17/22; H04L 29/08

(52) U.S. Cl. CPC G06F 17/2288; G06F 17/2247; H04L 67/02; H04L 67/306

(57) ABSTRACT

A contextual profile system is provided with an on-line social network system. In response to a request from a member of the on-line social network system to access a profile page of another member, the contextual profile system determines the context of the request, determines associated key profile units based on the context, and constructs a custom version of the other member's profile page. The custom version of the profile page is then presented to the requesting member.

### TECHNICAL FIELD

This application relates to the technical fields of software and/or hardware technology and, in one example embodiment, to system and method to produce contextual profile for a member in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to produce contextual profile for a member in an on-line social network system may be implemented;

FIG. 2 is block diagram of a system to produce contextual profile for a member in an on-line social network system, in accordance with one example embodiment;

FIG. 3 is a flow chart illustrating a method to produce contextual profile for a member in an on-line social network system, in accordance with an example embodiment; and

FIG. 4 is a diagrammatic representation of an example machine in the form of a computer system within which a set of instructions, for causing the machine to perform any one or more of the methodologies discussed herein, may be executed.

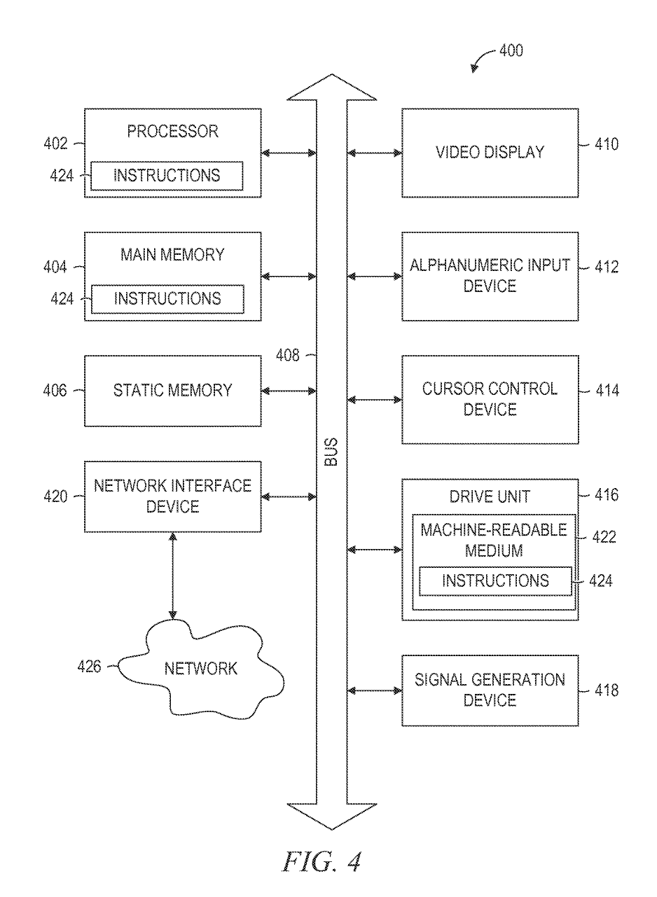

### DETAILED DESCRIPTION

A method and system to produce contextual profile for a member in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method describe herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in he context of the social network, in that they can view each other's profiles, profile recommendations and endorsements for each other and otherwise be in touch via the social network. Members that are connected in this way to a particular member may be referred to as that particular member's connections or as that particular member's network.

The profile information of a social network member may include various information such as, e.g., the name of the member, current and previous geographic location of the member, current and previous employment information of the member, information related to education of the member, information about professional accomplishments of the member, publications, patents, etc. The profile information of a social network member may also include information about the member's professional skills. A particular type of information that may be present in a profile, such as, e.g., company, industry, job position, etc., is referred to as a profile attribute. A profile attribute for a particular member profile may have one or more values. For example, a profile attribute may represent a company and be termed the company attribute. The company attribute in a particular profile may have values representing respective identifications of companies, at which the associated member has been employed. Other examples of profile attributes are the industry attribute and the region attribute. Respective values of the industry attribute and the region attribute in a member profile may indicate that the associated member is employed in the banking industry in San Francisco Bay Area.

In order to increase engagement among members, an on-line social network system may include a platform for providing so-called contextual profiles. The platform for providing so-called contextual profiles is configured to employ methodologies for presenting a member profile to a viewer in a manner that highlights or makes readily available information that best serves the goals of the viewer with respect to the viewed profile. The member to whom another member's profile is to be presented is referred to as a viewer (as that member is the consumer of the profile), and the member who's profile is being viewed is referred to as a viewee (as the insights involving that member are being viewed).

Viewing a member's profile page is often associated with a value proposition, such as, e.g., getting a job, recruiting, searching for prospects for sales leads, marketing products or services, etc. For example, when a value proposition is getting a job, the goal of the viewer may be to determine whether the member, whose profile is being viewed, would be helpful in the viewer's job search and perhaps would connect the viewer to a company or a job that the viewer is interested in. With this kind of goal, the profile data that would be of most importance to the viewer may be the viewee's connections to a particular job or particular company, e.g., references to profile pages of those connections of the viewee that list titles indicative of the specific job and/or list the particular company as a place of present or past employment. It may then be beneficial to rearrange the viewee's profile in such a way that the information perceived to be of most importance to the viewer-references to profile pages of those connections of the viewee that list titles indicative of the specific job and/or list the particular company as a place of present or past employment—is presented prominently to the viewer.

A system for presenting a profile of a member in a manner that is based on the perceived intent of a viewer for accessing that profile may be termed a contextual profile system. Various components of a member profile, such as, e.g., the title field, employment section, connections information, etc., may be referred to as profile units. A profile unit may be a data field that has a particular type of content. For example, a tittle entity has content identifying the member's professional title. A profile unit may be a group of data fields. For example, a profile unit may be a connection entity has references to one or more respective profiles of the member's connection. A profile unit may also be a visual control such as, e.g., a call to action button actionable to request a certain action. Examples of call to action buttons include a control actionable to request to connect with, to message, or to follow the associated member. Information from a viewee's profile determined to be of most importance to the viewer may be referred to as key profile units. The intent of the viewer may be inferred by means of examining context associated with the viewer's request to view the viewee's profile. The context, in one example embodiment, is a set of conditions associated with the viewer's request. The context is also associated with an identification of an intent stored as mapping information in a databased maintained by or accessible by the contextual profile system.

In one example scenario, a viewer may be accessing a viewee's profile with a goal of finding a job. This goal may be expressed by an intent item in a database labeled as “Job search” intent. The “Job search” intent could be stored as mapped to or associated with a set of those profile units that are deemed to be potentially helpful to the viewer who is in the process of a job search. A condition indicative of the “Job search” intent may be the viewer requesting access to the viewee's profile from a particular source web page or a particular section of a source page. The key profile units mapped to the “Job search” intent could be the viewee's title and company, as well as relevant connections of the viewee that may be of interest to the viewer. For example, if the viewer requested access to the viewee's profile from a search results web page produced in response to processing a search that includes search terms such as “job,” or “product manager,” or “ACME corporation,” the relevant connections may be those connections from the viewee's profile that include in their respective profiles the company name “ACME corporation” and/or a title string “product manager.” As mentioned above, the mapping information that maps intents to respective sets of key profile units may be stored in a database maintained by or accessible by the contextual profile system.

Using the set of key profile units associated with the determined intent, the contextual profile system constructs a personalized visualization of the viewee's profile, such that the data from the key profile units is included in the visible presentation area of the personalized visualization. For the purposes of this description, the visible presentation area is to be understood as the portion of the visualization that is to be presented on a display device as the personalized visualization is loaded for viewing, while the viewable presentation area of the personalized visualization is accessible for viewing by a further action, such as, e.g., a scrolling action.

Some examples of various ways, in which the context associated with the viewer and the associated intent can affect the presentation of a custom presentation of the viewed profile are provided below. The profile units could be reordered to display key profile units more prominently. The contextual profile system may add or hide certain profile units. The contextual profile system may select which call to action controls to be shown to the viewer. In some embodiments, certain words, phrases, or profile units may be highlighted. Highlighting may be accomplished, e.g., by providing a different background color, animating the profile unit etc.

Some example intents that can be mapped to respective sets of key profile units and stored as mapping information are described below.

As mentioned above, an intent may be associated with a particular source web page. In some embodiments, an intent may be determined by a sequence of activities performed by the viewee with respect to the on-line social network system, e.g., by the last few web pages accessed by the viewer prior to requesting access to the viewee's profile. An intent may be also determined by the identification of the viewer as a certain type of professional, e.g., a sales professional, a recruiter, a marketing specialist, etc. An intent may be associated with a source web page, from which the request to view a profile arises or a particular section of a source web page. A source web page or a web page, from which a request to view the viewee's profile originated. For example, a viewer may be landing on a profile page of another member from a news feed page, or from a search results web page, or, e.g., from a portion of a home page that suggests visiting a profile page of a member that has just became a connection of the viewer. Another example of intent is an intent associated with a relationship or an interaction between a viewer and a viewee, which may be termed a relationship-based intent. A relationship between a viewer and a viewee may be, e.g., determined by a pending message from the viewee to the viewer or by a pending connect request from the viewee to the viewer. A relationship between a viewer and a viewee may also be indicated by the viewer having shared content posted by the viewee or any other interaction by the viewer with respect to content posted by the viewee, as well as by the nature of such content. Another relationship-based intent may be determined based on previous views of the viewee's profile by the viewer. This intent may be mapped to those profile units that have their data modified since the last view of the profile by the viewer. Yet another example of intent is an intent determined by certain search terms. For example, if a viewer searched specifically for the viewee's profile by entering the viewee's name, the contextual profile system may emphasize the viewee's professional experience, and the profile units that include information about the viewee's professional experience may be mapped to that intent.

A member of the on-line social network can specify their interests by indicating in their profile that they wish to follow certain companies, schools, news topics, other members, or that they wish to be a part of different groups. These wishes can be expressed in the viewer's profile by so-called “follow” signals. In some embodiments, in response to a request to access a viewee's profile, the contextual profile system examines the “follow” signals in the viewer's profile and highlights in the custom presentation of the viewer's profile any “follow” signals that correspond to the respective “follow” signals in the viewer's profile.

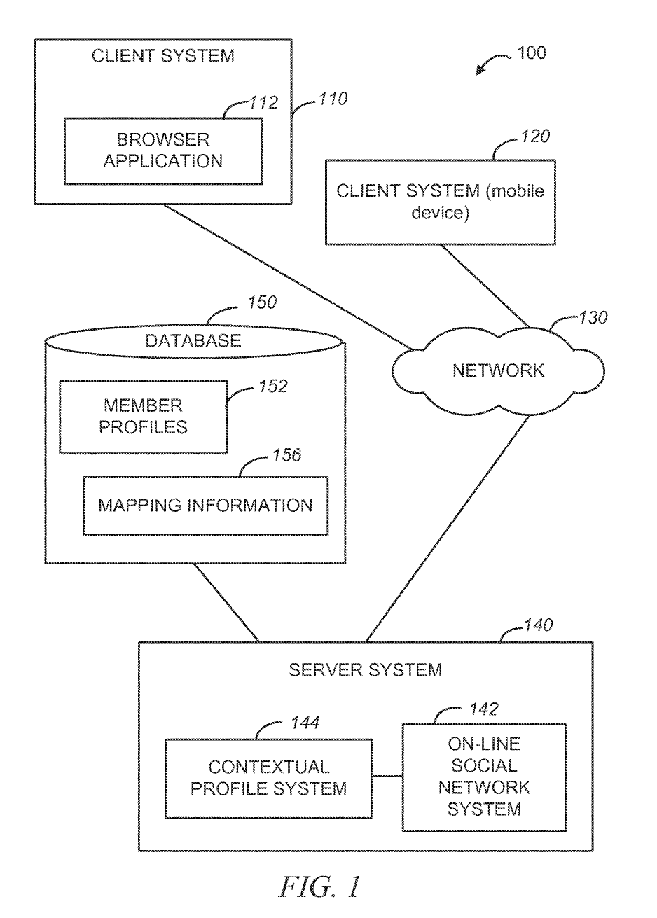

In operation, according to one example embodiment, the contextual profile system, in response to detecting a request from a viewer to access a profile of a viewee, determines the context of the request based on detected one or more conditions, such as the source page of the request, the relationship between the viewer and the viewee, etc., based on the determined context determines the intent and the associated key profile units, and constructs a custom version of the viewee's profile page. Thus constructed custom version of the viewee's profile page is then presented to the viewer. An example contextual profile system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

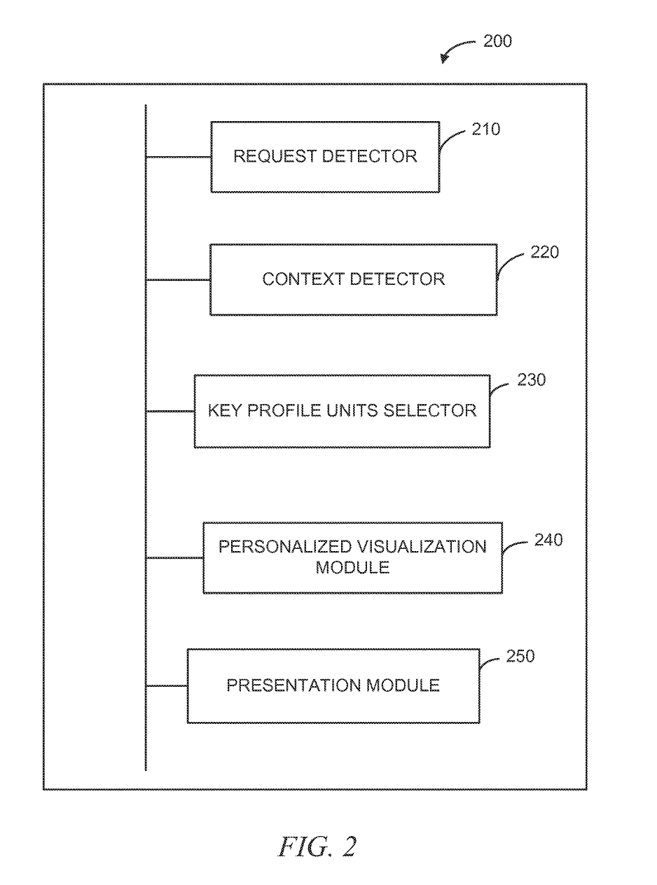

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a contextual profile system 144. The contextual profile system 144 may be configured to detect a request from a viewer to access a profile of a viewee, determine the context of the request based on detected one or more conditions (such as the source page of the request, the relationship between the viewer and the viewee, etc.), based on the determined context determine the intent and the associated key profile units, and to construct a custom version of the viewee's profile page. The custom version of the viewee's profile page is presented to the viewer. An example contextual profile system 144 is illustrated in FIG. 2.

FIG. 2 is a block diagram of a system 200 to produce contextual profile for a member in an on-line social network system 142 of FIG. 1. As shown in FIG. 2, the system 200 includes a context detector 220, a key profile units selector 230, a personalized visualization module 240, and a presentation module 250. The request detector 210 is configured to detect a request indicating a viewer profile and a viewee profile. The viewer profile and the viewee profile represent respective members in an on-line social network. The viewee profile comprises a plurality of profile units, such as, e.g., a title profile unit for storing a title string indicative of the professional title of the associated member, a company profile unit for storing a company string indicative of the employer of the associated member, one or more visual controls actionable to initiate respective requests (e.g., a request to connect follow, to send a message, etc.), a connections profile unit listing references to member profiles connected to the profile of the associated member, etc.

The context detector 220 is configured to determine context of the request indicating a viewer profile and a viewee profile, which could be a request from a member represented by the viewer profile to view the viewee profile. The context detector 220 may be further configured to determine the identification of intent associated with the context, access mapping information and locate an intent record based on the identification of intent, and select the one or more key profile units mapped to the located intent. In order to determine context, the context detector 220 may determine a source web page, from which the request indicating the viewee profile was initiated or a source section of the source web page. In one embodiment, if the source web page is a search results web page generated in response to a search comprising a search term, associated intent may be mapped a profile unit that includes a reference to a connected member profile that includes a phrase corresponding to or matching the search term. For example, if the source web page is a search results web page generated in response to a search comprising a search term “ACME Corporation,” the associated intent may be mapped a profile unit that includes a reference to a member profile that indicates “ACME Corporation,” as a place of employment of a member represented by that member profile.

The key profile units selector 230 is configured to determine one or more key profile units from the plurality of profile units based on the context determined by the context detector 220. The personalized visualization module 240 is configured to construct a personalized visualization of the viewee profile. The personalized visualization is constructed to have a visible presentation area and a viewable presentation area. The visible presentation area is to be presented on a display device as the personalized visualization is loaded for viewing, while the viewable presentation area is accessible for viewing by a further action, such as, e.g., the scrolling action. The one or more key profile units are included into the visible presentation area.

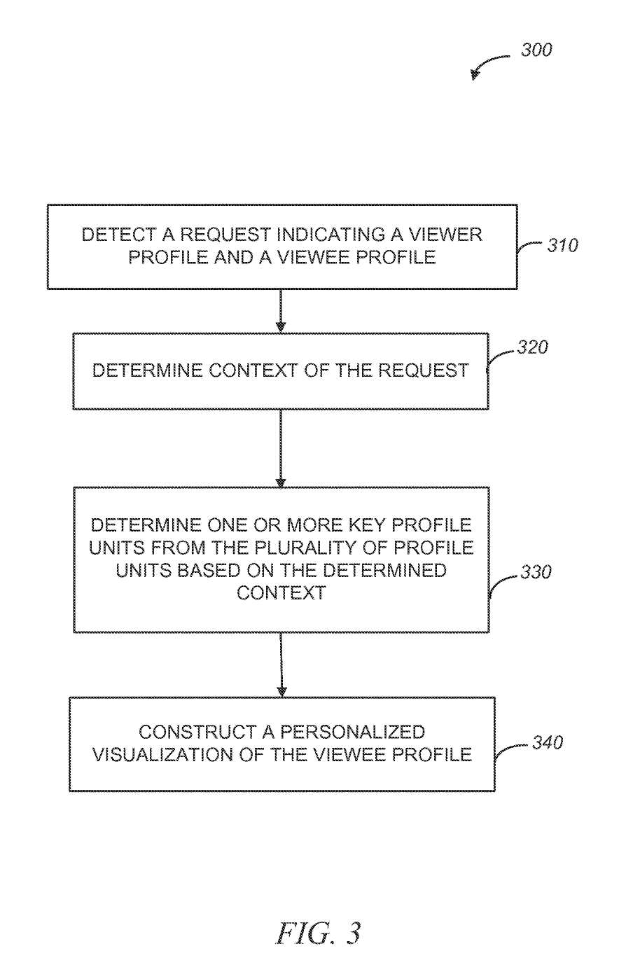

In order to determine context, the context detector 220 may determine a relationship between the viewer profile and the viewee profile, wherein the relationship between the viewer profile and the viewee profile is associated, e.g., with a pending connect request. The context detector 220 may also determine a characteristic of the viewer profile, such as an indication that a member represented by the viewer profile is a recruiter or a sales professional, or a marketing professional. An intent identification associate with a characteristic of the viewer profile may be mapped to the key profile entities that are deemed to be most relevant to viewers represented by profiles having that characteristic. The presentation module 250 is configured to cause presentation of the personalized visualization of the viewee profile on a display device. Some operations performed by the system 200 may be described with reference to FIG. 3.

FIG. 3 is a flow chart of a method 300 to produce contextual profile for a member in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the context detector 220 determines context of the request indicating a viewer profile and a viewee profile. The request could be a request from a member represented by the viewer profile to view the viewee profile. At operation 230, the key profile units selector 230 determines one or more key profile units from the plurality of profile units based on the context determined by the context detector 220. In one embodiment, the determined context of the request is associated with an identification of intent, and the key profile units selector 230 determines the one or more key profile units by accessing mapping information that stores the sets of key profile units as mapped to respective intents. At operation 240, the personalized visualization module 240 constructs a personalized visualization of the viewee profile. The personalized visualization has a visible presentation area and a viewable presentation area. The visible presentation area is to be presented on a display device as the personalized visualization is loaded for viewing, while the viewable presentation area is accessible for viewing by a further action, such as, e.g., the scrolling action. The one or more key profile units are included into the visible presentation area. The presentation module 250 causes presentation of the personalized visualization of the viewee profile on a display device at operation 250.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to pertbi in one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (GPU) or both), a main memory 504 and a static memory 506, which communicate with each other via a bus 505. The computer system 500 may further include a video display unit 510 (e.g., a liquid crystal display (LCD) or a cathode ray tube (CRT)). The computer system 500 also includes an alpha-numeric input device 512 (e.g., a keyboard), a user interface (UI) navigation device 514 (e.g., a cursor control device), a disk drive unit 516, a signal_{—} generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to produce contextual profile for a member in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
detecting a request indicating a viewer profile and a viewee profile, the viewer profile and the viewee profile representing respective members in an on-line social network, the viewee profile comprising a plurality of profile units;
determining context of the request;
based on the determined context, determine one or more key profile units from the plurality of profile units, using at least one processor;
construct a personalized visualization of the viewee profile, the personalized visualization having a visible presentation area and a viewable presentation area, the visible presentation area to be presented on a display device as the personalized visualization is loaded for viewing, the viewable presentation area accessible for viewing by a further action, the constructing comprising including the one or more key profile units into the visible presentation area; and
causing presentation of the personalized visualization of the viewee profile on a display device.

2. The method of claim 1, wherein the determined context of the request is associated with an identification of intent, the determining of the one or more key profile units comprises accessing mapping information, the mapping information comprising the one or more key profile units mapped to the intent.

3. The method of claim 1, wherein the determining of the context of the request comprises determining a source web page, from which the request indicating the viewee profile was initiated.

4. The method of claim 3, wherein the determining of the context comprises determining a source section of the source web page.

5. The method of claim 3, wherein:
the source web page is a search results web page generated in response to a search comprising a search term; and
the one or more key profile units comprise a profile unit that includes a reference to a connected member profile, the connected member profile representing a member connected to the viewee profile and including a phrase corresponding to the search term.

6. The method of claim 1, wherein the determining of the context of the request comprises determining a relationship between the viewer profile and the viewee profile.

7. The method of claim 6, wherein the relationship between the viewer profile and the viewee profile is associated with a pending connect request.

8. The method of claim 1, wherein the determining of the context of the request comprises determining a characteristic of the viewer profile.

9. The method of claim 8, wherein the characteristic of the viewer profile is an indication that a member represented by the viewer profile is a recruiter.

10. The method of claim 8, wherein the further action is a scrolling action.

11. A computer-implemented system comprising:
a request detector, implemented using at least one processor, to detect a request indicating a viewer profile and a viewee profile, the viewer profile and the viewee profile representing respective members in an on-line social network, the viewee profile comprising a plurality of profile units;
a context detector, implemented using at least one processor, to determine context of the request;
a key profile units selector, implemented using at least one processor, to determine one or more key profile units from the plurality of profile units based on the determined context;
a personalized visualization module, implemented using at least one processor, to construct a personalized visualization of the viewee profile, the personalized visualization having a visible presentation area and a viewable presentation area, the visible presentation area to be presented on a display device as the personalized visualization is loaded for viewing, the viewable presentation area accessible for viewing by a further action, the constructing comprising including the one or more key profile units into the visible presentation area; and
a presentation module, implemented using at least one processor, to cause presentation of the personalized visualization of the viewee profile on a display device.

12. The system of claim 11, wherein the determined context of the request is associated with an identification of intent, the determining of the one or more key profile units comprises accessing mapping information, the mapping information comprising the one or more key profile units mapped to the intent.

13. The system of claim 11, wherein the context detector is to determine a source web page, from which the request indicating the viewee profile was initiated.

14. The system of claim 13, wherein the context detector is to determine a source section of the source web page.

15. The system of claim 13, wherein:
the source web page is a search results web page generated in response to a search comprising a search term; and
the one or more key profile units comprise a profile unit that includes a reference to a connected member profile, the connected member profile representing a member connected to the viewee profile and including a phrase corresponding to the search term.

16. The system of claim 11, wherein the context detector is to determine a relationship between the viewer profile and the viewee profile.

17. The system of claim 16, wherein the relationship between the viewer profile and the viewee profile is associated with a pending connect request.

18. The system of claim 11, wherein t the context detector is to determine a characteristic of the viewer profile.

19. The system of claim 18, wherein the characteristic of the viewer profile is an indication that a member represented by the viewer profile is a recruiter.

20. A machine-readable non-transitory storage medium having instruction data executable by a machine to cause the machine to perform operations comprising:
detecting a request indicating a viewer profile and a viewee profile, the viewer profile and the viewee profile representing respective members in an on-line social network, the viewee profile comprising a plurality of profile units;
determining context of the request;
based on the determined context, determining one or more key profile units from the plurality of profile units;
constructing a personalized visualization of the viewee profile, the personalized visualization having a visible presentation area and a viewable presentation area, the visible presentation area to be presented on a display device as the personalized visualization is loaded for viewing, the viewable presentation area accessible for viewing by a further action, the constructing comprising including the one or more key profile units into the visible presentation area; and
causing presentation of the personalized visualization of the viewee profile on a display device.
